(19) United States
(12) Patent Application Publication
(10) Pub. No.: US 2013/0305825 A1
(43) Pub. Date: Nov. 21, 2013

(54) METHOD OF MONITORING THE POSITION OF A VALVE

(71) Applicants: Joseph Comparetto, Palestine, TX (US); Kenneth Wilson, Palestine, TX (US)

(72) Inventors: Joseph Comparetto, Palestine, TX (US); Kenneth Wilson, Palestine, TX (US)

(21) Appl. No.: 13/895,984

(22) Filed: May 16, 2013

Related U.S. Application Data
(60) Provisional application No. 61/648,074, filed on May 16, 2012.

(51) Int. Cl. G01N 29/44

(52) U.S. Cl. CPC G01N 29/4427
USPC 73/579

(57) ABSTRACT

A method of detecting a valve position includes imparting a vibration-inducing energy to a valve, detecting vibration of the valve and producing a sensor signal corresponding to the vibration of the valve, processing the sensor signal determining a measured response of the valve, and comparing the measured response to one or more predetermined characteristic frequencies for selected valve positions to determine the position of the valve.

This application claims priority to and the benefit of U.S. Provisional Patent Application No.

### BACKGROUND AND SUMMARY

Various valves are used in downhole and pipeline operations for oil and gas extraction and transportation. Valves are employed to control the flow into and out of wells and along pipelines. In certain installations, the demanding environment within the valve has made it difficult to reliably control the position of the valve. Further, particularly in downhole environments, certain installations have been difficult to reliably monitor the position of the valve between an open position and a closed position.

What is disclosed is a method of determining the position of a valve in a closed position, an opened position, or a position in between. The method includes the steps of imparting a vibration-inducing energy to a valve, detecting vibration of the valve and producing a sensor signal corresponding to the vibration of the valve, processing the sensor signal determining a measured response of the valve, and comparing the measured response to one or more predetermined characteristics for selected valve positions to determine the position of the valve.

The step of detecting vibration may include one or more strain gauges producing the sensor signal, and the step of processing the sensor signal may include processing the strain gauge data to convert the sensor signal from a function of time to a function of frequency.

### BRIEF DESCRIPTION OF THE DRAWINGS

FIG. 1 is a schematic flow chart of a valve measuring system of the present disclosure;

FIG. 2 is a graph showing the harmonic response of a vibrating 9 inch Mueller Co. valve;

FIG. 3 is a graph showing the harmonic response for a plurality of data sets from a vibrating 4 inch valve in an open position;

FIG. 4 is a detail of the graph of FIG. 3 showing the response between 800 and 1800 Hz (open valve position);

FIG. 5 is a graph showing data collected for a plurality of data sets from the same 4 inch valve used for the data in FIG. 3, in an open position;

FIG. 6 is another graph showing noise data collected for the 4 inch valve in an open position;

FIG. 7 is a graph showing the response of FIG. 5 between 250 and 400 Hz (open valve position);

FIG. 8 is a graph showing the response of FIG. 6 highlighting a different subset of data (open valve position);

FIG. 9 is a graph showing the harmonic response for a plurality of data sets from the 4 inch valve in a closed position;

FIG. 10 is a graph showing the response of FIG. 9 between 200 and 300 Hz (closed valve position);

FIG. 11 is a graph showing the collective data of nearly 40 different sample runs for the response of the 4 inch valve in the open position;

FIG. 12 is a graph showing the collective data of nearly 40 different sample runs for the response of the 4 inch valve in the closed position; and

FIG. 13 is a graph showing the collective data of nearly 40 different sample runs measuring noise values for the 4 inch valve.

### DETAILED DESCRIPTION OF PREFERRED EMBODIMENTS

A valve typically has a closed position in which the valve operatively prevents flow of fluid through the valve, and an opened position in which the valve operatively enables full flow through the valve. Additionally, many valves are not on/off valves, but enable variable and/or partially-restricted flow by valve positions between the opened and closed positions. The present invention may be provided to determine the position of a valve for many types of valves, such as gate valves, wedge valves, flow control valves, barrier valves, check valves, fluid-loss valves, sliding sleeve valves, and other valves.

In one embodiment, the present method for determining the position of a valve includes steps of creating a carefully defined forcing function based on a pseudo-random source, amplifying this forcing function to a suitable amplitude imparting a vibration-inducing energy to a valve, detecting vibration of the valve and producing a sensor signal corresponding to the vibration of the valve, processing the sensor signal determining a measured response of the valve, and comparing the measured response to one or more predetermined characteristics for selected valve positions to determine the position of the valve. The energy input to the valve may create the vibration as phonon waves through the valve. The vibration of the valve in response to the energy input and the corresponding measured response of the valve to the energy input is dependent upon the position of the valve. As such, the valve provides a transfer function having characteristic features dependent on valve position such that reverse analysis is possible; e.g., that the position of the valve may be determined by the response to an energy input.

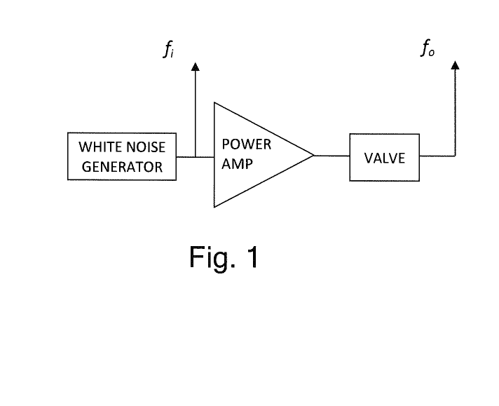

For each valve in a given application, characteristics of the vibration of the valve change as the valve position changes. The relationship between the signal output and the energy input is a transfer function that is useful for determining the valve position. For a given valve, a transfer function having characteristics dependent on valve position may be measured. The transfer function, F(x) representing valve position is a function of the signal response, fₒ, (output) divided by the driving signal, fᵢ (input) such as illustrated by the flow chart of FIG. 1.

$$F ( x ) = \frac{{f}_{o}}{{f}_{i}}$$

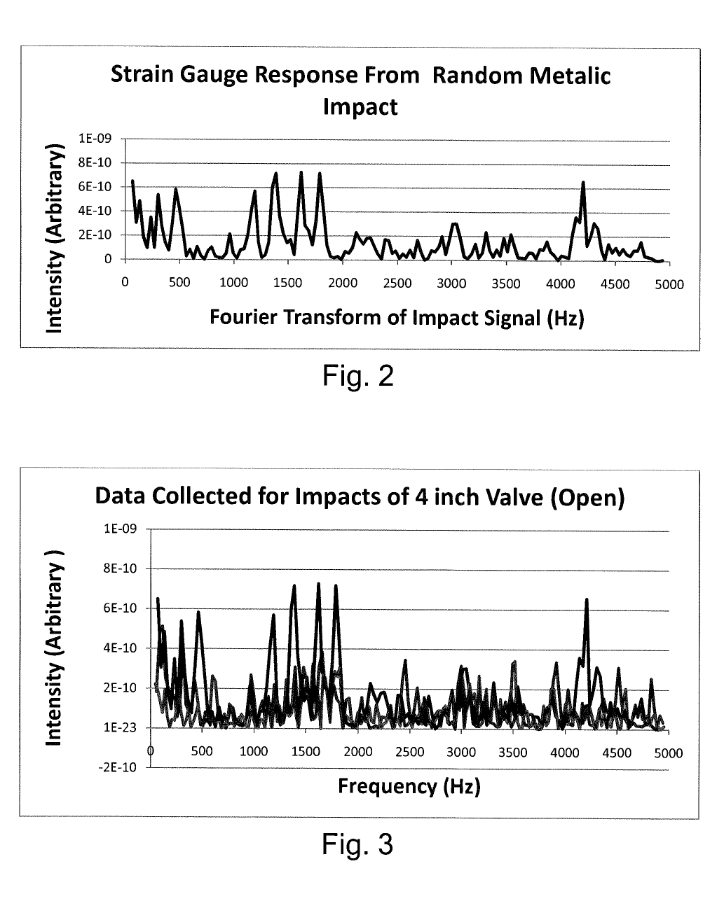

As an example, a response (fₒ) from a 9 inch valve is shown in FIG. 2 with the valve in a valve open position. A response from a 4 inch valve is shown in FIG. 3 with the valve in a valve open position. In each case, the response includes characteristic frequencies, or eigenfrequencies, representing resonance frequencies of the valve in the valve position. As the valve position changes, the eigenfrequencies change. As such, for each valve position a transfer function response or a frequency response may include one or more eigenfrequencies that are characteristic of that valve position and distinct from other valve positions. The natural frequencies of the valve are dependent on many variables, including the mass of the valve, the materials used in the construction of the valve, the valve geometry, including the valve position, the pressure of the fluid in the valve, the properties of the fluid in the valve, and attenuating factors such as the earth around the valve in a downhole application.

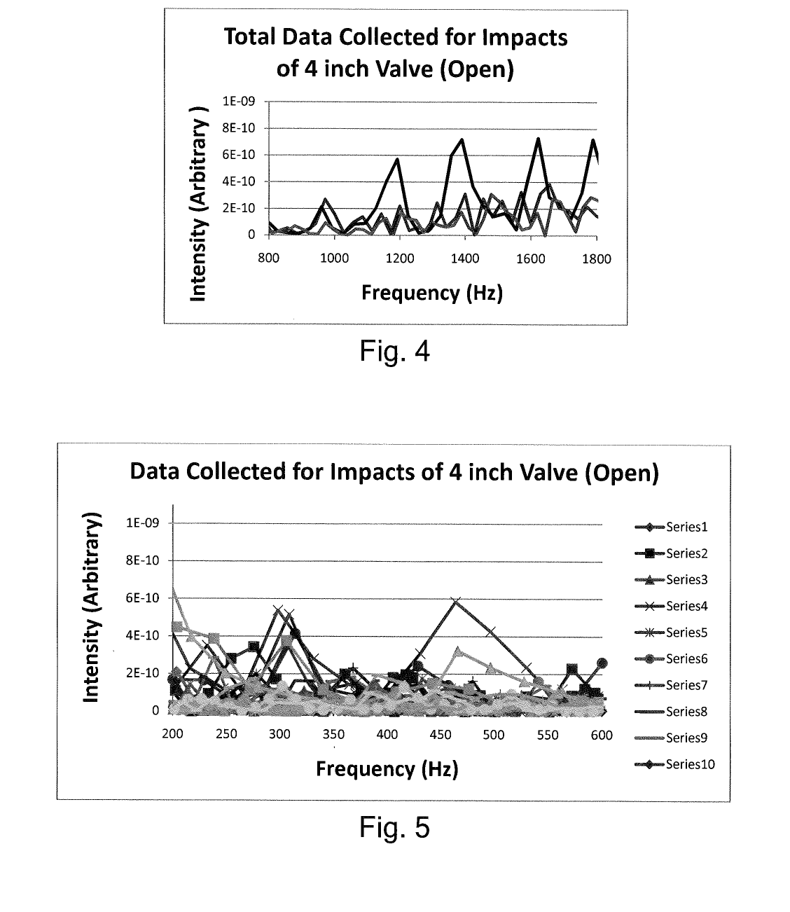

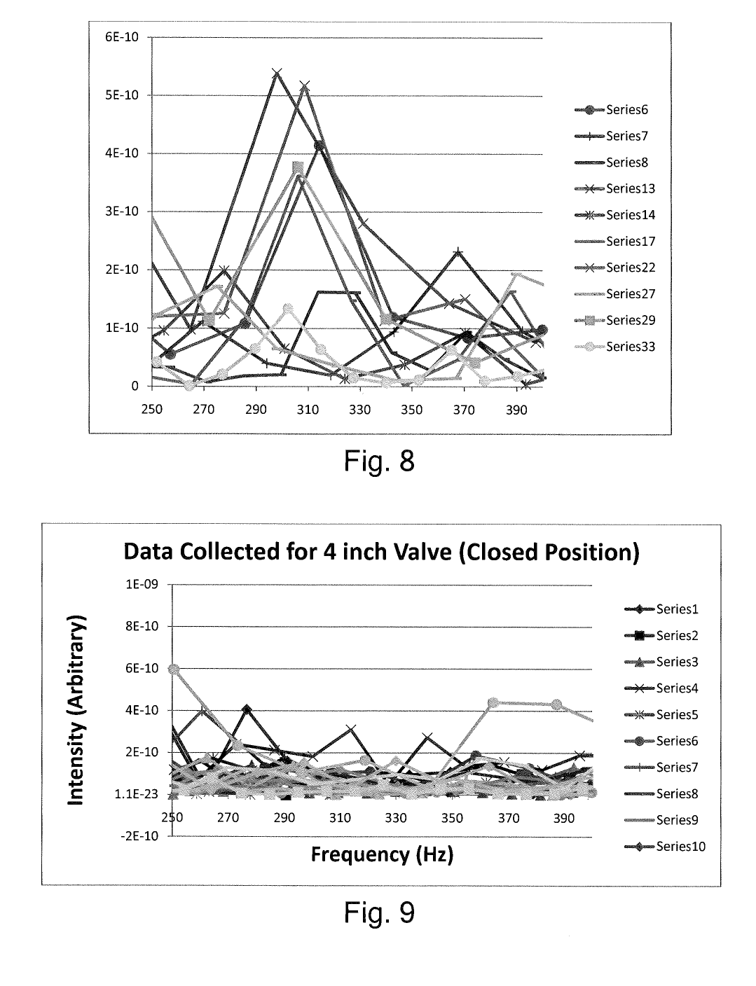

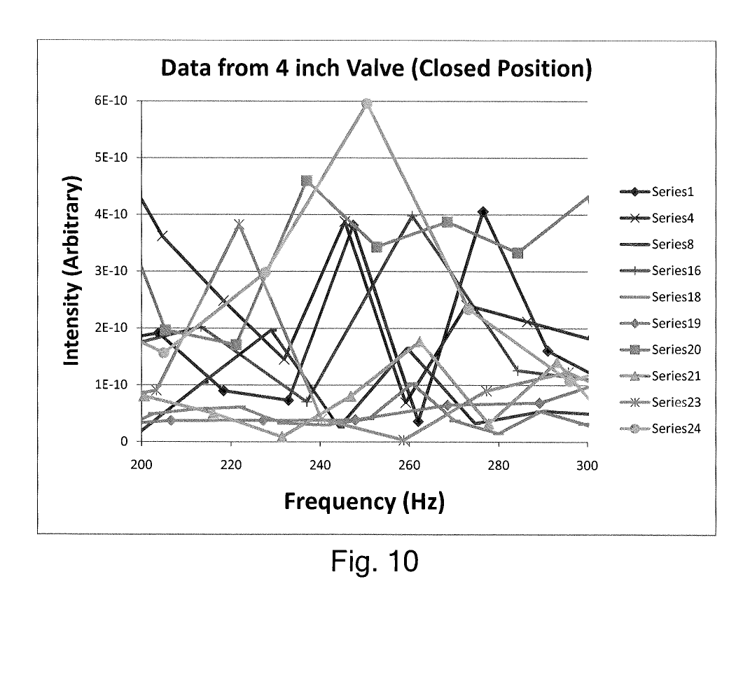

In the present process, the valve in an unknown position may be excited by a vibration and a response is measured. Then the measured response is compared to one or more predetermined characteristics for selected valve positions to determine the position of the valve. For example, discussed further below with reference to FIGS. 8 and 10, the 4 inch valve in an unknown valve position may be determined by imparting a vibration-inducing energy to the valve, and sensing the resulting vibration to generate a measured response. Then, the measured response may be compared to characteristic frequencies at 250 Hz, the characteristic frequency for this valve in a closed position (see FIG. 8), and 300 Hz, the characteristic frequency for this valve in an opened position (see FIG. 10), to determine whether the measured response indicates that the valve is open or closed. More than one characteristic frequency may be used to compare to the measured response. For example, further discussed below with respect to FIG. 4, peaks indicating characteristic frequencies are observed between 1200 and 1400 Hz, and shown in FIG. 2, around 520 Hz and 4900 Hz. Any number or combination of eigenfrequencies may form the characteristics used to distinguish between various valve positions. As used herein, the “response” includes any electronic signal or data representing the vibration of the valve, including frequency response, transfer function, or any other signal transformation or modification. The response typically is a function of frequency, but in certain applications may be expressed in terms of time, voltage, resistance, current, or other sensor output. Additionally, the valve position may be determined by correlating comparisons between time domain artifacts to frequency domain artifacts to distinguish between valve positions.

The measured response for a given valve may be used to determine the valve position. However, for any given valve and valve position, the eigenfrequencies for the particular geometry and application may not be apparent without modeling of the system and/or empirical measurement. For a given valve installation, the transfer function relating the energy input and the resulting vibration signal is measured. The transfer function including characteristics distinct for selected valve positions may be determined by measuring the response to a known input or driving signal when the valve is in selected known positions, such as the open position, closed position, and various positions between open and closed as desired. Then, for the known valve positions, various eigenfrequencies in the responses that differentiate between open, closed, and other valve positions may be selected as characteristics of the particular valve positions.

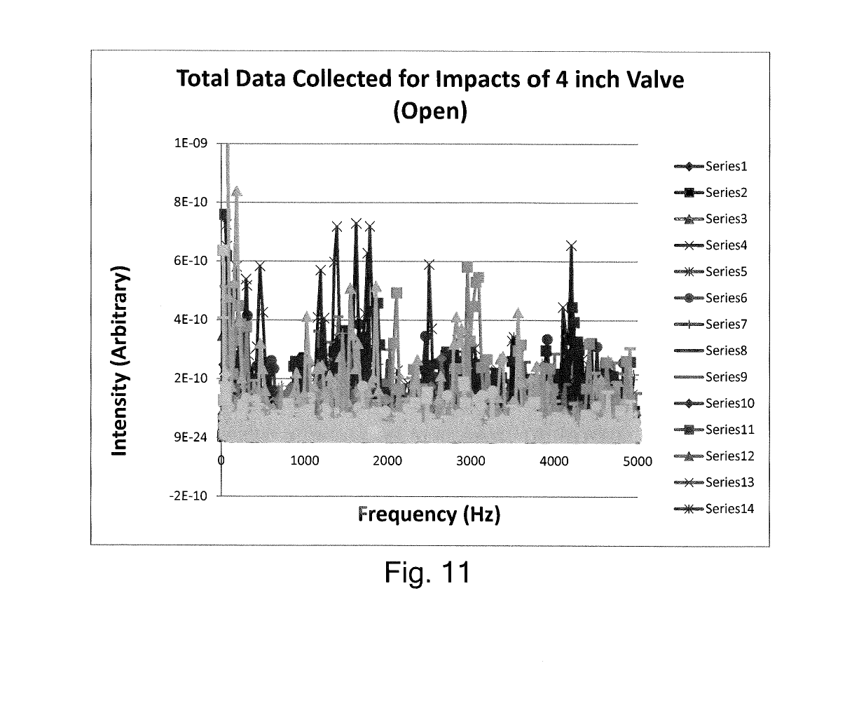

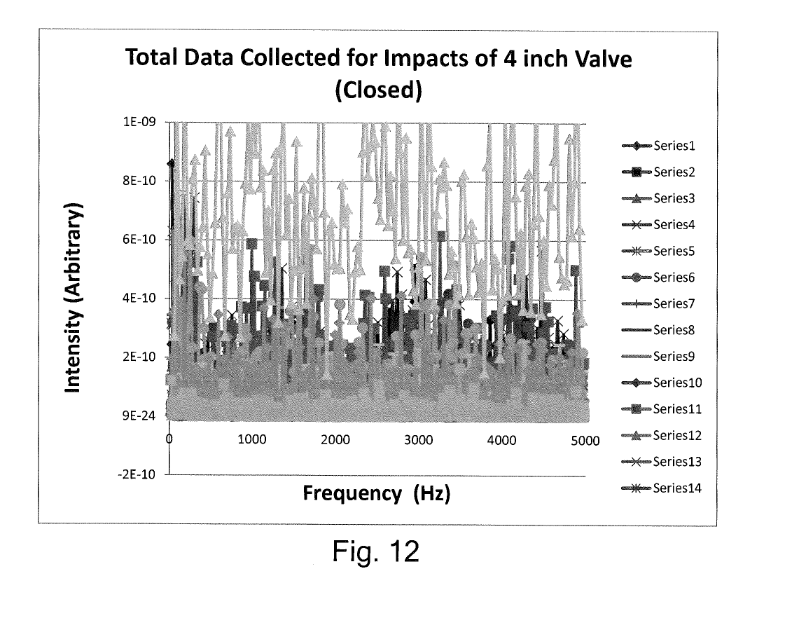

For each valve system, the measured response includes vibration at a multitude of frequencies that is considered to be noise. The eigenfrequencies are typically found by discerning those frequencies that have an amplitude or intensity (the y-axis values in FIGS. 2-13) that is generally greater than the amplitude of the noise.

The vibration sensor for measuring the response may be selected from a group consisting of strain gauge, accelerometer, microphone, voice coil, and other sensor able to detect vibration attached to or adjacent the valve housing. However, any sensor capable of measuring the vibration of the valve may be used. In certain applications, a second sensor may be provided adjacent the source of vibration for monitoring the driving signal. When a second sensor is provided, the driving signal measured by the second sensor may be compared to the response signal received by the first sensor in determining the response of the valve. In certain applications, the response signal measured by the first sensor may be divided by the driving signal measured by the second sensor creating a transfer function response. In any event, the measured response may be compared to one or more predetermined characteristics for selected valve positions to determine the position of the valve.

To determine the response of the valve, an amount of energy must be imparted to the system. Imparting energy to the valve may be done by a driving mechanism such as a mechanical vibration device, sonic tone generator, acoustic oscillator or another vibration generator. A mechanical vibration device may be positioned adjacent the valve adapted to provide a physical vibration or impact to impart energy, such as by a hammer mechanism, eccentric rotator, or other device. Alternatively, sonic tone generators or acoustic oscillators may be provided adjacent the valve to drive a vibration in the valve. In one application, a random white noise generator may be used to generate an energy input to induce vibration in the valve. In certain applications, sonic tone generators may be operatively connected to a power amplifier which outputs through a noise coil mounted to the valve housing.

The driving mechanism induces a vibration to the valve system by desired driving frequencies enabling the valve to vibrate at its natural frequencies. After imparting energy to the system, the driving input may be turned off and the system allowed to vibrate freely while the response is measured by the sensor. Alternatively, the valve vibration may continue to be driven while the response is measured and the natural frequencies and the driving frequencies distinguished in the signal processing.

In one application, a random white noise generator may be used to generate an energy input to induce vibration in the valve with a continuously driven input across a predetermined range of frequencies. The random frequencies generated by a white noise generator excite natural frequencies across a frequency range at the same time, enabling efficient measurement of the eigenfrequencies characteristic of the valve position. In this application, two sensors may be provided, one to measure the driving signal and one to measure the response signal. The transfer function response may be determined by dividing the measured signal by the driving signal. Then the transfer function response is compared to one or more predetermined characteristics for selected valve positions to determine the position of the valve.

The amplitude or intensity (the y-axis values in FIGS. 2-13) of the measured signal varies with the magnitude of the energy input without significantly changing the response (the x-values in FIGS. 2-13). This is because the response, for a given valve position, includes one or more eigenfrequencies that are approximately the same for inputs of different magnitudes. This property may be used to control the vibration-inducing energy input to the valve. For example, the magnitude of the energy input may be adjusted to maintain the amplitude of eigenfrequencies at a desired amount greater than the general amplitude of the noise. In this way, energy can be reduced when the driving signal is greater than needed to discern the eigenfrequencies over the noise, and energy can be increased when the eigenfrequencies are within the noise.

The driving mechanism may induce a vibration in the valve by directly imparting energy to the valve. Alternatively, vibration may be induced in other components of the system in communication with the valve, such as adjacent piping, or valve actuation mechanism, or other components.

Typically, infrasound frequencies are below 20 Hz, acoustic frequencies are from 20 Hz to 20,000 Hz, and ultrasound frequencies are 20,000 Hz and greater. The term “acoustic” as used herein is not limited to frequencies capable of human auditory detection, and more generally is used herein referring to detectable frequencies of vibration. In the given figures, many modes of vibration are seen between 200 Hz and 5,000 Hz; however it is contemplated that infrasound, ultrasound, and various acoustic frequencies may be applied.

In certain applications, electromagnetic techniques could be used for valve position detection. However, it is contemplated that the frequencies used would have to be very low, such as below 50 Hz. Additionally, the detection of the wave based on position may be more difficult to implement.

In preliminary tests of the present method, a 9 inch gate valve made by Mueller Co. and a 4 inch gate valve made by Mueller Co. were tested. In each preliminary test, a strain gauge was attached to the outside of the valve on a flat surface adjacent the actuating stem. The strain gauge was connected to a computer programmed for data acquisition using LabView by National Instruments Corporation, although any suitable data acquisition configuration may be adapted.

The response of the valves was tested by imparting a vibration-inducing energy to the outside of the valve. In the preliminary test procedure, the valve housing was impacted using a hammer to induce a vibration through the valve. The vibration of the valve was measured by the strain gauge, and the strain gauge signal was acquired and processed with the use of signal conditioning tools. The strain gauge signal included a voltage signal directly proportional to the strain at the strain gauge.

The strain gauge sensor signal was processed determining the measured response of the valve. A Fourier transform was used to transform the sensor signal from a function of time to a function of frequency. The graphs shown in the figures present the Fourier-transformed data, not the raw data itself.

In the experiments graphed in the figures, the application of energy to the valve was not consistent, resulting in variation in the amplitude of the different responses. While the amplitude or intensity (y-axis value) was different for most iterations, the measured response (x-value) was very similar, if not the same, from one energy application to the next. As discussed above, this is because the measured response, for a given valve position, includes one or more eigenfrequencies that are approximately the same for inputs of different magnitudes.

As shown in FIGS. 2 and 3, a variety of peaks can be seen for the vibrating valve. To determine the characteristic frequencies of the valve, the response for a valve was collected with the valve in the open position and closed position. Additionally, the responses were analyzed to evaluate noise in the valve system. Referring now to FIG. 4, in the frequencies between about 1200 and 1400 Hz, each of the three data sets shown exhibit peaks at about 1200 and 1400 Hz for the 4 inch valve in the open position. Note that the intensity of these peaks is dependent on the input energy; however, as discussed above, the location of eigenfrequencies is a function of the valve geometry in the valve position.

As shown in FIG. 5, a number of peaks are found in the range of 200-600 Hz, and more particularly in the area of 300 Hz for the 4 inch valve in the open position. Even though 10 series are listed in the legend of FIG. 5, FIG. 5 includes nearly 40 data sets plotted in the graph.

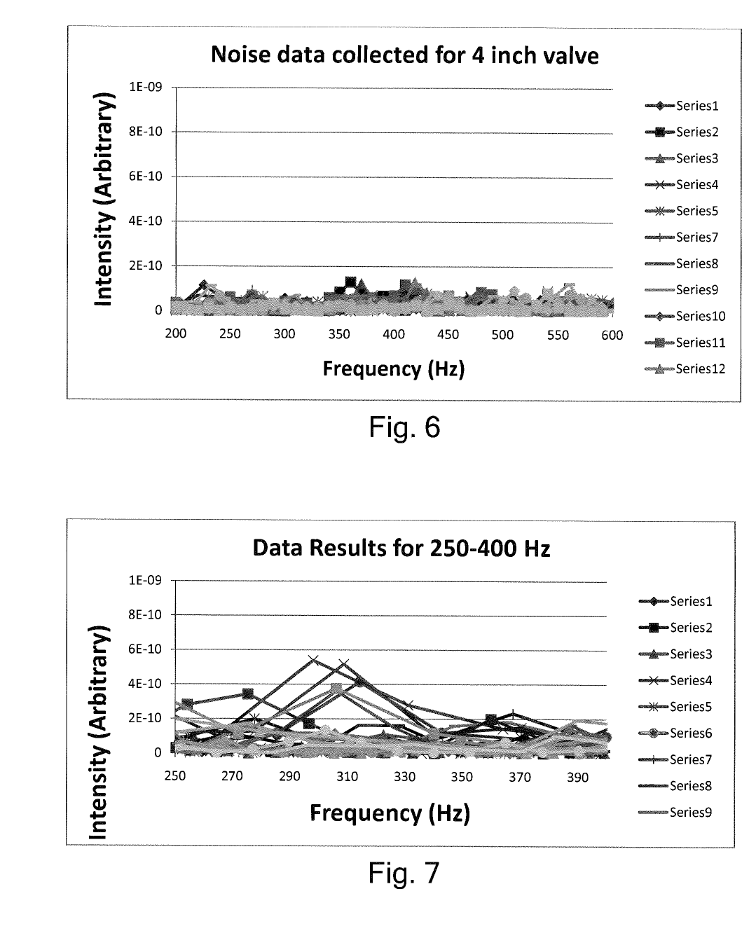

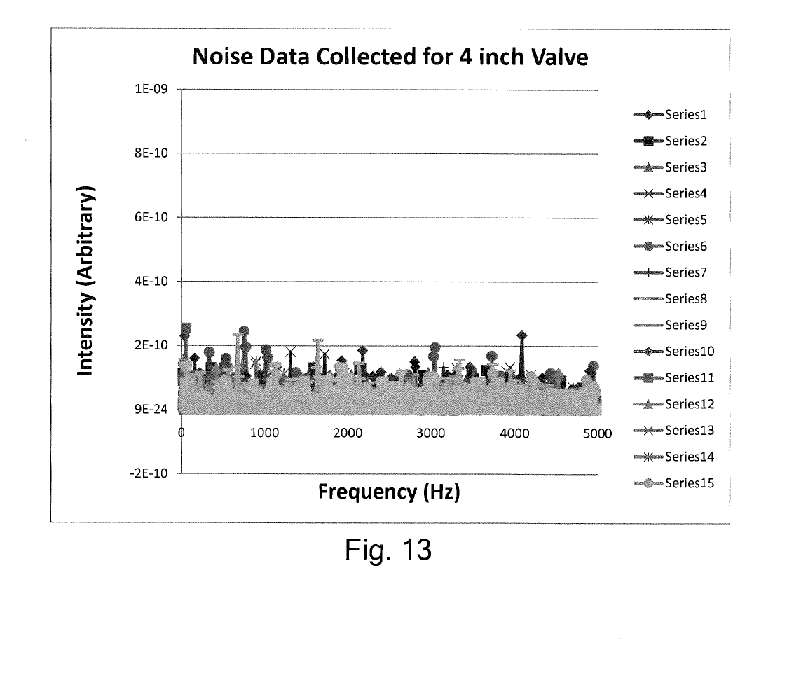

A number of test runs were sampled to differentiate between useful eigenfrequencies and system noise, as shown in FIGS. 6 and 13. The normalized data indicated that signal intensity below about 1e-10 included system noise. Values above 1e-10 are generally not considered noise. The peaks in FIG. 5 around 300 Hz, due to their intensity, are not noise. In the range of about 200 to 400 Hz in FIG. 5, the peaks are about 5 times larger in magnitude than the background noise. In FIG. 6, even though only 12 series are listed in the legend, nearly 40 data sets are plotted in the graph.

FIG. 7 includes the frequency response between 250 and 400 Hz for the 4 inch valve in the open position. To further clarify the data shown in FIG. 7, FIG. 8 includes a subset of the data shown in FIG. 7. Over 10 samples showed a peak between 275 and 315 Hz, all of which were above the 1e-10 background noise level (see FIG. 6 discussed above). FIG. 8 shows that the peak location is repeatable for the valve, and indicates that there is an eigenfrequency in the response for the valve in the open position between about 290 and 320 Hz.

The valve provides a different response in the closed position. FIGS. 9 and 10 show the frequency response of the 4 inch valve in the closed position. No repeatable peak is observed in the area around 300 Hz when the valve is closed, indicating that the eigenfrequencies for the valve in the closed position is not the same as for the valve in the open position. The valve in the closed position includes peaks around 250 Hz, which are shifted about 50 Hz from the peaks when the valve is in the open position as shown in FIG. 8. The signal is above the background noise level, and is considered to be a characteristic vibration of the valve when it is in the closed position.

From the testing of the 4 inch valve, the measured response is a strong indication that the sampled valve has a characteristic natural frequency around 300 Hz in the open position, and around 250 Hz in the closed position. Eigenfrequencies in other frequency ranges may also be compared and differentiated between open and closed positions. It is contemplated that with consistency of inducing vibration and use of filtering techniques, the position of the valve is reliably detected.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected by the appended claims and the equivalents thereof.

What is claimed is:

1. A method of detecting a valve position comprising:
imparting a vibration-inducing energy input to a valve;
detecting vibration of the valve and producing a sensor signal corresponding to the vibration of the valve;
processing the sensor signal determining a measured response of the valve;
comparing the measured response to one or more predetermined characteristics for selected valve positions to determine the position of the valve.

2. The method of detecting a valve position according to claim 1, where the relationship between the sensor signal and the energy input is a transfer function dependent on the valve position.

3. The method of detecting a valve position according to claim 1, further comprising:
providing a vibration sensor on the valve; and the step of detecting vibration comprising:
measuring the vibration sensor signal corresponding to the vibration of the valve.

4. The method of detecting a valve position according to claim 3, where the step of processing the sensor signal comprises:
processing the vibration sensor signal to convert the sensor signal from a function of time to a function of frequency.

5. The method of detecting a valve position according to claim 3 where the vibration sensor is selected from a group consisting of strain gauge, accelerometer, microphone, voice coil, and other sensor able to detect vibration.

6. The method of detecting a valve position according to claim 1, where the step of imparting a vibration-inducing energy comprises:
generating a random white noise to provide an energy input inducing vibration in the valve.

7. The method of detecting a valve position according to claim 1, where the step of imparting a vibration-inducing energy comprises:
amplifying the energy input such that the predetermined characteristics have an amplitude a desired amount greater than a general amplitude of noise.

8. The method of detecting a valve position according to claim 7, further comprising
reducing the input energy when the amplitude of the predetermined characteristics is greater than needed to distinguish them over the noise.

9. The method of detecting a valve position according to claim 1, where the predetermined characteristics include one or more frequencies that distinguish between valve positions determined by modeling of the system or empirical measurement.

10. The method of detecting a valve position according to claim 1, further comprising
correlating comparisons between time domain artifacts to frequency domain artifacts to distinguish between valve positions.

11. A method of detecting a valve position comprising:
generating a random vibration input energy inducing vibration in a valve;
detecting vibration of the valve and producing a sensor signal corresponding to the vibration of the valve;
processing the sensor signal determining a measured response of the valve;
comparing the measured response to one or more predetermined characteristics for selected valve positions to determine the position of the valve.

12. The method of detecting a valve position according to claim 11, where the relationship between the sensor signal and the energy input is a transfer function dependent on the valve position.

13. The method of detecting a valve position according to claim 11, further comprising:
providing a vibration sensor on the valve; and the step of detecting vibration comprising:
measuring the vibration sensor signal corresponding to the vibration of the valve.

14. The method of detecting a valve position according to claim 13, where the step of processing the sensor signal comprises:
processing the vibration sensor signal to convert the sensor signal from a function of time to a function of frequency.

15. The method of detecting a valve position according to claim 13 where the vibration sensor is selected from the group consisting of strain gauge, accelerometer, microphone, and other sensor able to detect vibration.

16. The method of detecting a valve position according to claim 11, where the step of imparting a vibration-inducing energy comprises:
amplifying the energy input such that the predetermined characteristics have an amplitude a desired amount greater than a general amplitude of noise.

17. The method of detecting a valve position according to claim 16, further comprising
reducing the input energy when the amplitude of the predetermined characteristics is greater than needed to distinguish them over the noise.

18. The method of detecting a valve position according to claim 11, where the predetermined characteristics include one or more frequencies that distinguish between valve positions determined by modeling of the system or empirical measurement.

19. The method of detecting a valve position according to claim 11, further comprising
correlating comparisons between time domain artifacts to frequency domain artifacts to distinguish between valve positions.
